(19) United States
(12) Patent Application Publication
(10) Pub. No.: US 2009/0072004 A1
(43) Pub. Date: Mar. 19, 2009

(54) POWERED INSULATED STAPLE GUN

(76) Inventors: Patrick J. Radle, Mequon, WI (US); Austin R. Braganza, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 12/210,714

(22) Filed: Sep. 15, 2008

Related U.S. Application Data
(63) Continuation of application No. 60/993,803, filed on Sep. 14, 2007.

(51) Int. Cl. B25C 5/00; B25C 5/10

(52) U.S. Cl. 227/130; 227/131; 227/120; 227/129; 227/135

(57) ABSTRACT

A device for applying insulated fasteners to a substrate is disclosed. The device comprises a housing that includes a fastener recess and an ejection recess, and the fastener recess is configured to accommodate insulated fasteners. The device further comprises a powered actuator that includes an ejection member that moves over a range of positions. The ejection member permits one of the insulated fasteners to enter the ejection recess in a retracted position, and the ejection member forces the one of the insulated fasteners to leave the ejection recess in an extended position. A power connector operatively connects the powered actuator to a power source to provide power to move the ejection member. A manual actuator is operatively disposed between the power source and the powered actuator to selectively provide power from the power source to the powered actuator.

### CROSS-REFERENCE TO RELATED APPLICATION

This application claims the benefit of U.S. Provisional Patent Application No. 60/993,803 filed Sep. 14, 2007, the disclosure of which is hereby incorporated by reference.

### STATEMENT CONCERNING FEDERALLY SPONSORED RESEARCH OR DEVELOPMENT

Not applicable.

### FIELD OF THE INVENTION

This invention relates to staple guns and specifically staple guns that apply insulated staples.

### BACKGROUND OF THE INVENTION

Insulated staples are commonly used to secure cables or wires to a substrate. An insulated staple typically includes two nails and a plastic bridge, or as shown in FIGS. 1b and 3b, is provided as an insulated staple 50 including a metal staple portion 52 with staple legs 54 that extend through a U-shaped plastic bridge 56 to fasten the bridge 56 to a substrate 60. As shown in FIG. 3b, the bridge 56 straddles a cable 70 to reduce the possibility of the metal staple portion 52 contacting or pinching the cable 70.

Insulated fasteners may be installed with a hand-held hammer. However, this process is time consuming and can easily fatigue an operator that repeatedly performs the task. As a result, manually driven fastening tools are commonly used for installing insulated fasteners. These tools save time compared to installing the fasteners with a hammer. Referring to FIGS. 1a, 2, and 3a, a manually driven fastening tool, such as a manually driven staple gun 10, typically includes a housing 12 with a fastener recess 14 that accommodates a plurality of insulated staples 50. The insulated staples 50, provided in a row and connected to each other by frangible connections as is well known, are biased towards an ejection member 16 due to a biasing force 18 that may be provided, for example, by a compressed spring. During operation, the manually driven staple gun 10 is positioned adjacent the substrate 60 and a handle 20 is pivoted toward the housing 12 by the user. Referring to FIG. 1a, the handle 20 engages a handle slot 22 in the ejection member 16 to raise the ejection member 16 and compress a spring 24. Referring to FIG. 2, the ejection member 16 moves to a retracted or cocked position to open an ejection recess 26 with an open bottom adjacent the fastener recess 14. One of the insulated staples 50 enters the ejection recess 26 due to the biasing force 18. Referring to FIG. 3a, continued rotation of the handle 20 causes the handle 20 to disengage the handle slot 22. As a result, the spring 24 pushes the ejection member 16 towards an extended position, and simultaneously, the ejection member 16 drives the insulated staple 50 down out of the ejection recess 26 through the open bottom of the recess 26 and into the substrate 60, breaking the frangible connection of the driven staple to the row of staples waiting to be driven. The last staple in the row is held in the ejection recess 26 by the staple feeding force 18 only, prior to the staple being driven. Thereafter, the handle 20 may be returned to its original position and the process may be repeated. The manually driven staple gun 10 may also include a cable guide 28 that holds the cable 70 in the appropriate position relative to the staples 50 during operation of the staple gun 10. Another example of a manually driven staple gun is disclosed in U.S. Patent Application Publication No. 2008/0156844 published Jul. 3, 2008, the disclosure of which is hereby incorporated by reference.

Although manually driven staple guns save time when installing a significant number of staples, prolonged use of this device can be fatiguing to the operator because each staple firing cycle requires the operator to squeeze the handle to compress the spring. Therefore, it would be desirable to have a fastening device that is not manually driven to reduce fatigue to the operator.

### SUMMARY OF THE INVENTION

In one aspect, the present invention provides a device for applying insulated fasteners to a substrate. The device comprises a housing that includes a fastener recess and an ejection recess, and the fastener recess is configured to accommodate the insulated fasteners. The device further comprises a powered actuator that includes an ejection member that moves over a range of positions. The range of positions includes a retracted position and an extended position. The ejection member permits one of the insulated fasteners to enter the space over the ejection opening in the retracted position, and the ejection member drives the one of the insulated fasteners down out of the ejection recess in the extended position. The device further comprises a power connector that operatively connects the powered actuator to a power source to provide power to move the ejection member. The device further comprises a switch that is operatively disposed between the power source and the powered actuator to selectively provide power from the power source to the powered actuator.

In another aspect, the present invention provides a device that comprises a housing that includes a fastener recess and an ejection recess, and the fastener recess is configured to accommodate the insulated fasteners in a configuration in which the insulated fasteners are coiled. The device further comprises an ejection member that moves over a range of positions. The range of positions includes a retracted position and an extended position. The ejection member permits one of the insulated fasteners to enter the ejection recess in the retracted position, and the ejection member forces the one of the insulated fasteners to leave the ejection recess down through the opening in the bottom of the recess in the extended position.

In another aspect, the present invention provides a device that comprises a fastener recess that is configured to accommodate the insulated fasteners and an ejection recess from which the insulated fasteners exit the device. The device further comprises a support handle that is configured to be grasped by a user during use of the device and an elongated section between the fastener recess and the support handle. The device further comprises an ejection member that moves over a range of positions. The range of positions includes a retracted position and an extended position. The ejection member permits one of the insulated fasteners to enter the ejection recess in the retracted position, and the ejection member forces the one of the insulated fasteners to leave the ejection recess in the extended position.

The foregoing and other objects and advantages of the invention will appear in the detailed description that follows. In the description, reference is made to the accompanying drawings that illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1a is a schematic side view of a manually driven staple gun with an ejection member in an extended position;

FIG. 1b is a schematic front view of an insulated staple before the staple is installed into a substrate;

FIG. 2 is a schematic side view of the manually driven staple gun of FIG. 1a with the ejection member in a retracted position;

FIG. 3a is a schematic side view of the manually driven staple gun of FIG. 1a with the ejection member returning to the extended position and forcing an insulated staple from an ejection recess;

FIG. 3b is a schematic front view of the insulated staple of FIG. 1b after the staple is installed into the substrate and holding a cable against the substrate;

FIG. 4 is a schematic side view of a powered insulated staple gun of the present invention that includes a solenoid actuator and an electrical plug that connects to a 120V wall socket; an ejection member of the staple gun is shown in a retracted position;

FIG. 5 is a schematic side view of the powered insulated staple gun of FIG. 4 with the ejection member in an extended position;

FIG. 6 is a schematic side view of a powered insulated staple gun of the present invention that includes a solenoid actuator and electrical wires to connect to a battery;

FIG. 7 is a schematic side view of a powered insulated staple gun of the present invention that includes a fuel combustion actuator and a fuel conduit to connect to a fuel source;

FIG. 8 is a schematic side view of a powered insulated staple gun of the present invention that includes a pneumatic actuator and an air conduit to connect to a compressed air source;

FIG. 9 is a perspective view of a coiled strip of insulated staples that may be used with the powered insulated staple gun; and

FIG. 10 is a perspective view of a powered insulated staple gun of the present invention with an elongated or extending body.

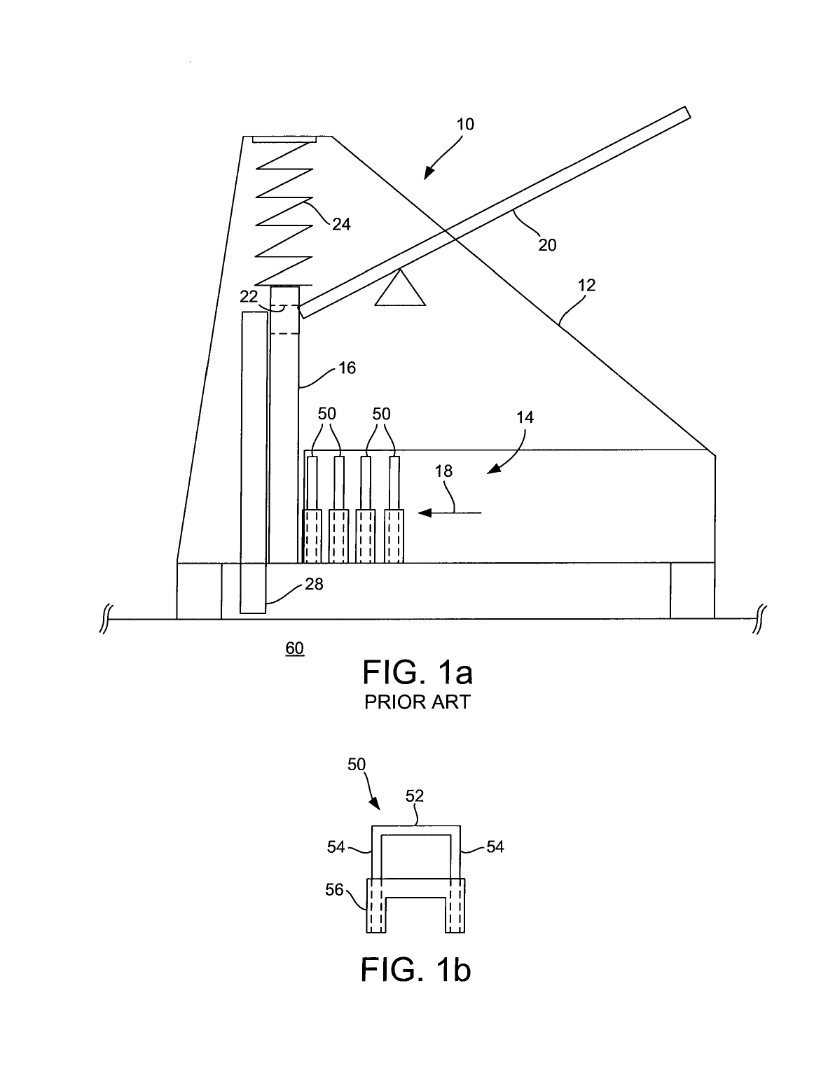

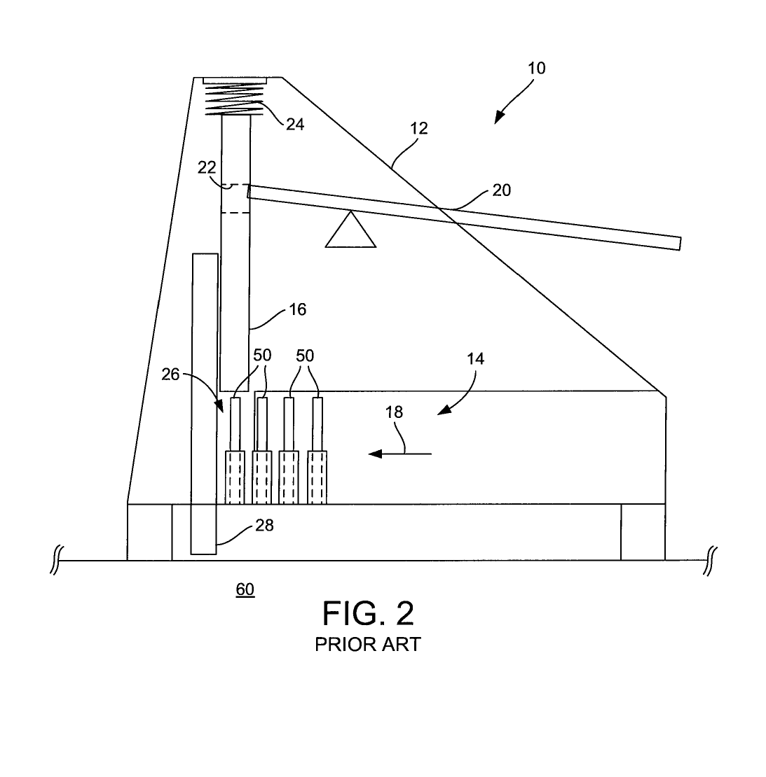

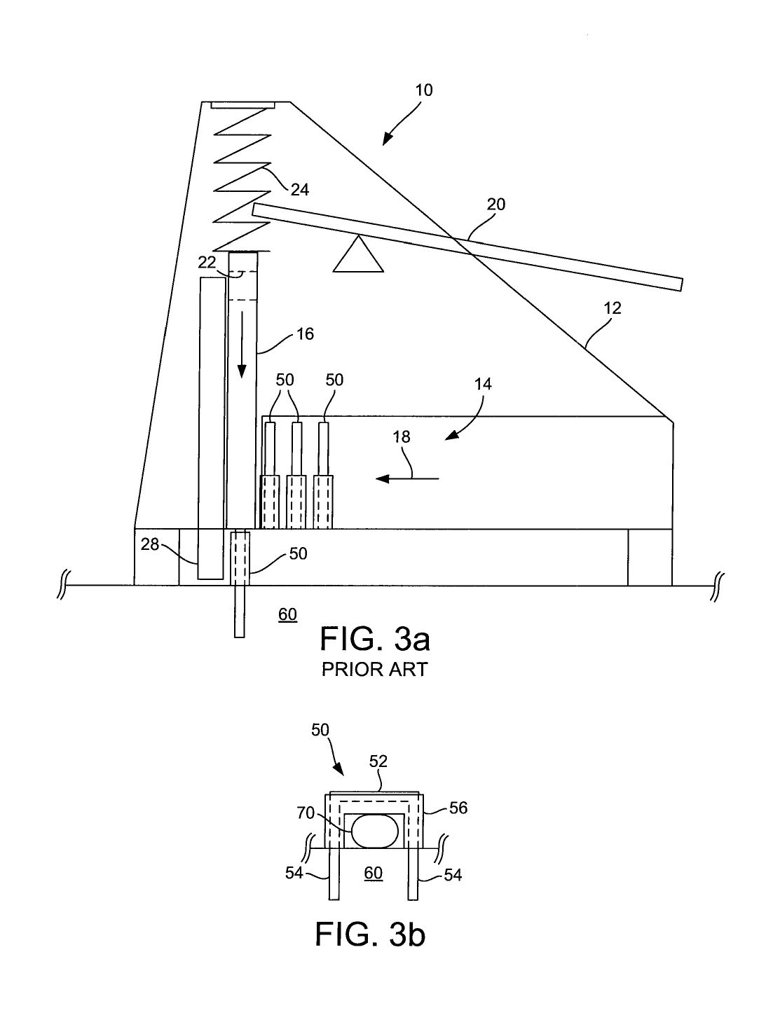

### DETAILED DESCRIPTION OF THE INVENTION

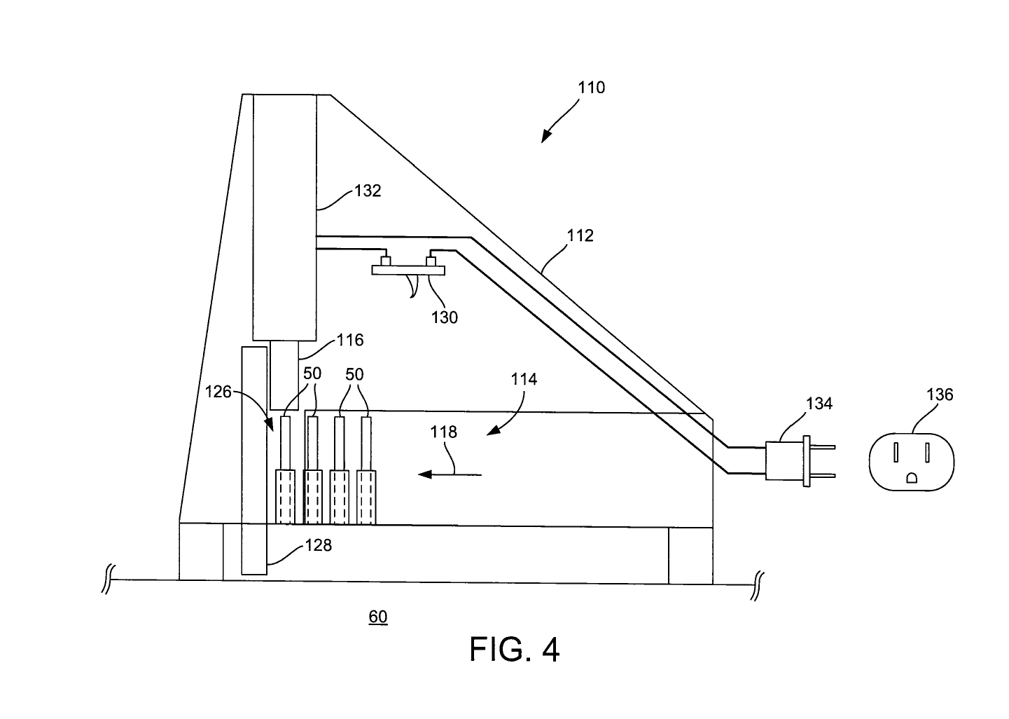

The present invention generally provides a powered fastening device, such as the powered insulated staple gun 110 shown in FIGS. 4-8, for installing insulated fasteners into a position to hold a cable 70 against a substrate 60. The powered insulated staple gun 110 includes a housing 112 with a fastener recess 114 that accommodates a plurality of insulated staples 50. The insulated staples 50 are biased towards an ejection member 116 due to a biasing force 118 that may be provided, for example, by a compressed spring. During operation, the powered insulated staple gun 110 is positioned adjacent the substrate 60 and the operator preferably applies sufficient force so that the staples 50 penetrate the substrate 60 rather than push off the substrate 60 when they are driven toward it. The operator also actuates a manual actuator, such as a trigger switch 130, to install a staple 50 into the substrate 60. Specifically, actuating the trigger switch 130 creates an operative connection between a powered actuator and a power source through a power connector to move the ejection member 116. As shown in FIG. 4, the powered actuator moves the ejection member 116 to a retracted position to open an ejection recess 126 adjacent the fastener recess 114. This may occur at the end of a driving stroke, so the retracted position is the normal position of the ejection mechanism when the trigger is not being depressed, with a staple waiting beneath it to be driven. The front one of the insulated staples 50 enters the ejection recess 126 due to the biasing force 118 when the ejection member 116 moves from the extended position to the retracted position. Thereafter, the powered actuator moves the ejection member 116 to the extended position, and in so moving the ejection member 116 drives the insulated staple 50 downwardly from the ejection recess 126 and into the substrate 60, in a direction perpendicular to the direction that the staple 50 entered the ejection recess 126. Only a single staple 50 is preferably pushed from the ejection recess 126 each time the operator actuates trigger switch 130. That is, the cycle of moving the ejection member 116 and installing the staples 50 preferably does not repeat continuously if the operator holds the trigger switch 130 in the actuated position. In addition, the powered insulated staple gun 110 may also include a cable guide 128 that holds the cable 70 in the appropriate position relative to the staples 50 during operation of the staple gun 110.

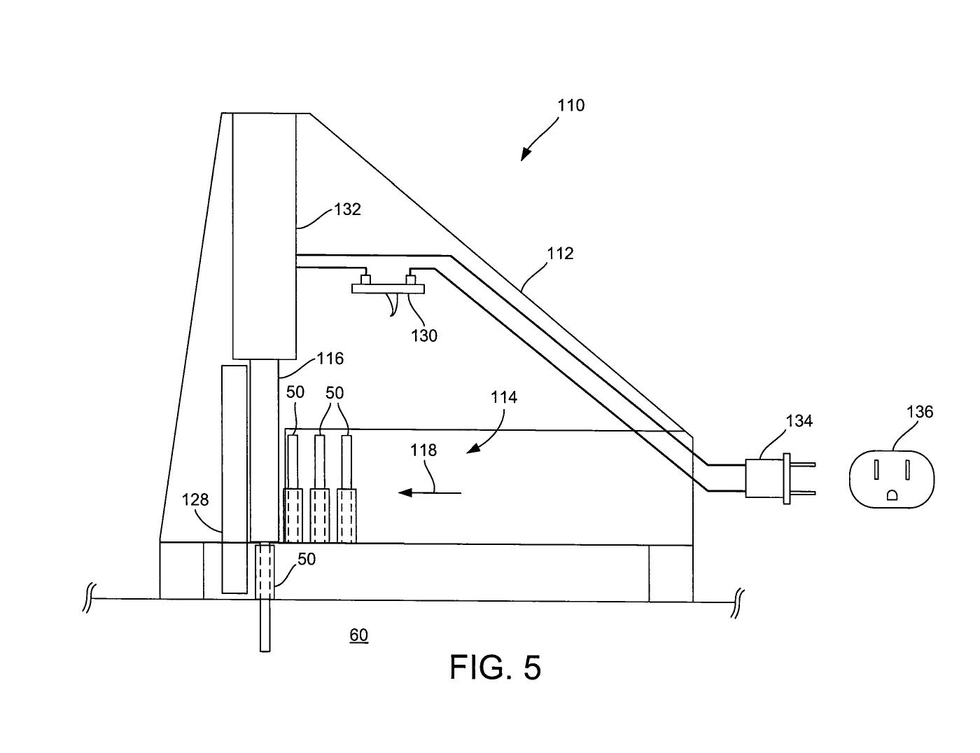

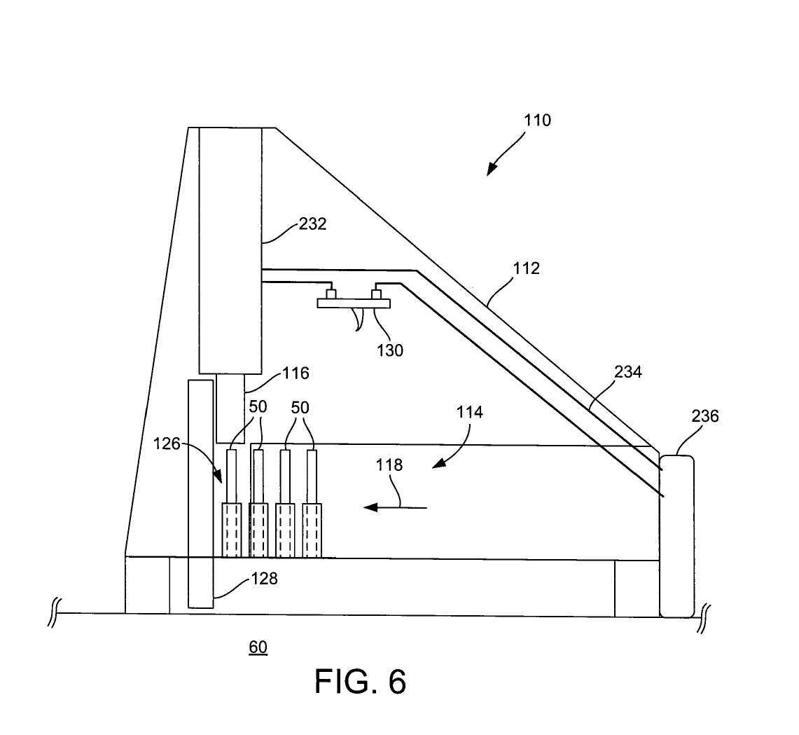

Referring to FIGS. 4 and 5, in some configurations the powered insulated staple gun 110 may include a solenoid actuator 132 as the powered actuator and an electrical plug 134 as the power connector. The electrical plug 134 operatively connects the solenoid actuator 132 to a power source, such as a 120V wall socket 136. In these configurations, the trigger switch 130 may close an electric circuit to permit the wall socket 136 to transfer power to the solenoid actuator 132. Referring to FIG. 6, in some configurations the powered insulated staple gun 110 may include a solenoid actuator 232 as the powered actuator and electrical wires 234 as the power connector. The electrical wires 234 operatively connect the solenoid actuator 232 to a battery 236 that acts as the power source. In these configurations, the trigger switch 130 may close an electric circuit to permit the battery 236 to transfer power to the solenoid actuator 232.

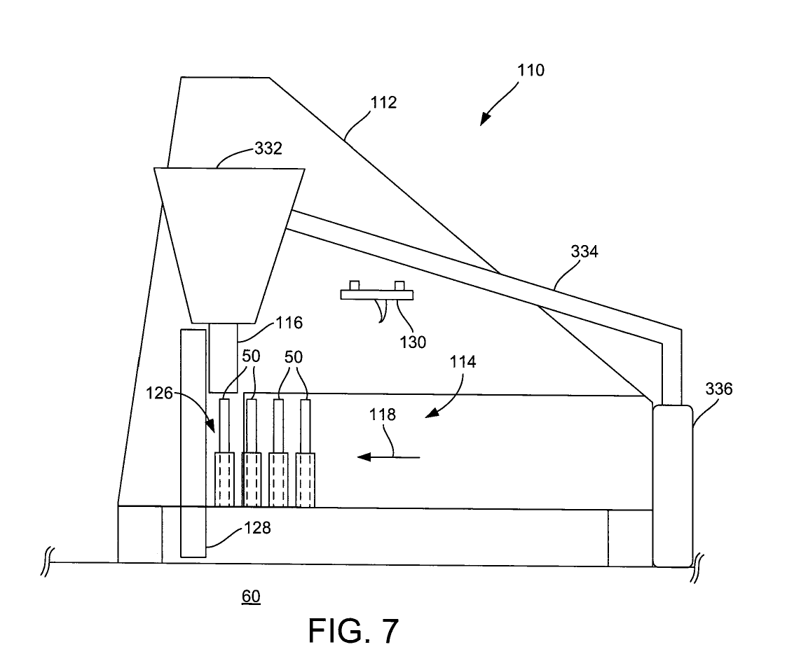

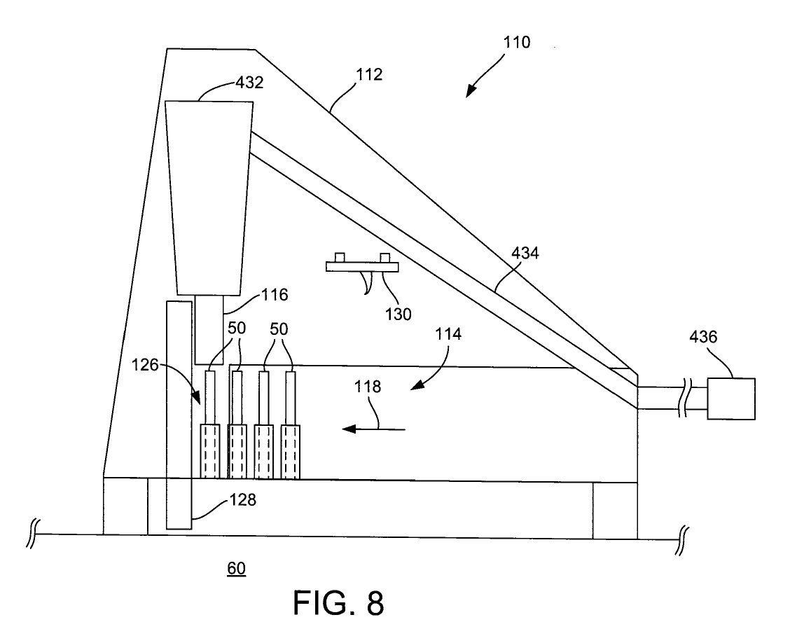

Referring to FIG. 7, in some configurations the powered insulated staple gun 110 may include a fuel combustion actuator 332 as the powered actuator and a fuel conduit 334 as the power connector. The fuel conduit 334 operatively connects the fuel combustion actuator 332 to a fuel source 336 that acts as the power source. In these configurations, the trigger switch 130 may open a valve (not shown) positioned along the fuel conduit 334 and activate a spark plug (not shown) to provide an ignition spark to the fuel combustion actuator 332. Referring to FIG. 8, in some configurations the powered insulated staple gun 110 may include a pneumatic actuator 432 as the powered actuator and an air conduit 434 as the power connector. The air conduit 434 operatively connects the pneumatic actuator 432 to a compressed air source 436 that acts as the power source. In these configurations, the trigger switch may open a valve (not shown) positioned along the air conduit 434 to provide compressed air to the pneumatic actuator 432.

Using any of these power sources, the power may be provided to load a spring that when released drives the staple, like a manual staple gun or the power may drive the staple directly. If the former, the normal position of the ejection member would typically be in the extended position, blocking the front staple from entering the ejection recess. Pressing the trigger would power the ejection member to be lifted from that position, allowing the front staple to move into the ejection recess position under the ejection member and when lifted would load a spring that would drive the staple into the substrate when the spring reaches the top of its stroke and is released. If the latter, the ejection member would be returned to the retracted position at the end of a driving stroke, either by spring or by power. In that case, pressing the trigger would power the ejection member downwardly, toward the staple to drive the staple into the substrate. Power mechanisms for driving staplers are known and could be applied to drive such a stapler.

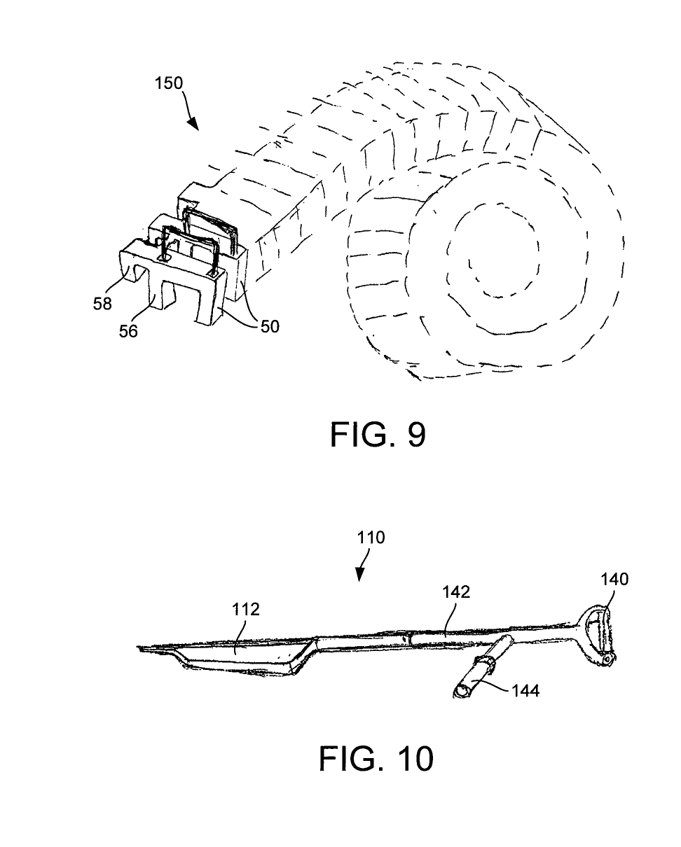

The powered insulated staple gun 110 permits the operator to install a significant number of staples with relatively low fatigue, and therefore a relatively large number of staples may be carried within the staple gun 110. Referring to FIG. 9 for example, a long strip of insulated staples may be arranged in a coiled configuration 150. Such a configuration advantageously reduces the frequency in which the staples 50 must be loaded into the fastener recess 114. During operation, a shorter length of staples may be separated from the coil 150 and inserted in the fastener recess 114. Alternatively, the fastener recess 114 and the housing 112 may be modified so that staples 50 may be fed directly and continuously to the ejection recess 126. Similarly, the bridge 56 of each staple 50 may include a tab 58 that permits the staple gun 110 to index and feed the staples 50 toward the ejection recess 126 and the ejection member 116.

Referring to FIG. 10, in some configurations the powered insulated staple gun 110 may include an elongated or extending body that permits staples 50 to be easily secured, for example, to a ceiling or floor studs. In these configurations, the powered insulated staple gun 110 includes a first support handle 140 and an elongated section 142 between the first support handle 140 and the housing 112. The staple gun 110 may also include a second support handle 144 that permits the operator to more easily position the staple gun 110. Further still, the elongated section 142 may be a telescoping section that permits the staple gun 110 to be reconfigured to a smaller size.

It is specifically intended that the present invention not be limited to the embodiments and illustrations contained herein, but include modified forms of those embodiments including portions of the embodiments and combinations of elements of different embodiments as come within the scope of the following claims.

We claim:

1. A device for applying insulated fasteners to a substrate, comprising:
a housing including an insulated fastener recess and an ejection recess, the insulated fastener recess being configured to accommodate insulated fasteners;
a powered actuator including an ejection member that moves over a range of positions including a retracted position and an extended position, the ejection member permitting a front one of the insulated fasteners contained in the insulated fastener recess to enter along a first direction the ejection recess in the retracted position of the ejection member, and the ejection member when moving to the extended position forcing the front one of the insulated fasteners to leave the ejection recess in a second direction substantially perpendicular to the first direction;
a power connector for operatively connecting the powered actuator to a power source to provide power to move the ejection member between the extended and retracted positions; and
a manual actuator operatively disposed between the power source and the powered actuator to selectively provide power from the power source to the powered actuator.

2. The device of claim 1, wherein the device is a staple gun and the insulated fasteners are insulated staples.

3. The device of claim 1, wherein the powered actuator is a solenoid actuator.

4. The device of claim 3, wherein the power connector is an electrical plug and the power source is a 120V wall socket.

5. The device of claim 3, wherein the power supply is a battery.

6. The device of claim 1, wherein the powered actuator is a fuel combustion actuator and the power source is a fuel source.

7. The device of claim 1, wherein the powered actuator is a pneumatic actuator and the power source is a compressed air source.

8. The device of claim 1, wherein the housing is configured to accommodate the insulated fasteners in a configuration in which the insulated fasteners are coiled.

9. The device of claim 1, wherein the housing further includes a support handle configured to be grasped by a user during use of the device, and an elongated section between the support handle and the housing.

10. The device of claim 9, wherein the elongated section is a telescoping section.

11. A device for applying insulated fasteners to a substrate, comprising:
a housing including a fastener recess and an ejection recess, the fastener recess being configured to accommodate insulated fasteners in a configuration in which the insulated fasteners are coiled; and
an ejection member that moves over a range of positions including a retracted position and an extended position, the ejection member permitting one of the insulated fasteners to enter the ejection recess in the retracted position, and the ejection member forcing the one of the insulated fasteners to leave the ejection recess in the extended position.

12. The device of claim 11, wherein the device is a staple gun and the insulated fasteners are insulated staples.

13. The device of claim 11, wherein the housing further includes a support handle configured to be grasped by a user during use of the device, and an elongated section between the support handle and the fastener recess.

14. The device of claim 13, wherein the elongated section is a telescoping section.

15. The device of claim 14, further comprising:
a powered actuator including the ejection member;
a power connector operatively connecting the powered actuator to a power source to provide power to move the ejection member; and
a manual actuator operatively disposed between the power source and the powered actuator to selectively provide power from the power source to the powered actuator.

16. A device for applying insulated fasteners to a substrate, comprising:
a fastener recess configured to accommodate insulated fasteners;
an ejection recess from which the insulated fasteners exit the device;
a support handle configured to be grasped by a user during use of the device;
an elongated section between the fastener recess and the support handle; and
an ejection member that moves over a range of positions including a retracted position and an extended position, the ejection member permitting one of the insulated fasteners to enter the ejection recess in the retracted position, and the ejection member forcing the one of the insulated fasteners to leave the ejection recess in the extended position.

17. The device of claim 16, wherein the device is a staple gun and the insulated fasteners are insulated staples.

18. The device of claim 16, wherein the elongated section is a telescoping section.
